(19) United States
(12) Patent Application Publication
(10) Pub. No.: US 2026/0031580 A1
(43) Pub. Date: Jan. 29, 2026

(54) INLET SYSTEM WITH CHARGING SOCKET

(71) Applicant: Ampure Charging Systems, Inc., Monrovia, CA (US)

(72) Inventor: Romica Popa, Monrovia, CA (US)

(21) Appl. No.: 18/780,816

(22) Filed: Jul. 23, 2024

(51) Int. Cl. H01R 13/713; B60L 53/16; H01R 13/73

(52) U.S. Cl. CPC H01R 13/713; B60L 53/16; H01R 13/73

(57) ABSTRACT

An inlet system comprises a first support configured to hold a charging socket and including at least one first guide pin portion, a second support configured to rotatably hold the first support in a horizontal plane and allow the first support to rotate horizontally according to movement of the charging socket, and a switch positioned near at least one of the first support and the second supports and configured to sense whether the first support rotates and switch the operation status of the charging socket when sensing the rotation of the first support.

### TECHNICAL FIELD

Embodiments relate generally to an inlet system, and more particularly to an inlet system with a charging socket for a vehicle.

### BACKGROUND

An electric vehicle can be electronically charged through a charger connecting between the vehicle and the external power source. The charging connector of the charger is removably coupled to the charging inlet of the vehicle and establishes an electrical connection between the vehicle and the external power source, such as a charging station. During the charging or feeding process, the vehicle has to be immobilized or only allowed to move within the range of the cable length of the charger to secure the stable mechanical connection and enable safe electrical connection therethrough. Once the charging process is completed or the user decides to stop the charging or feeding, the charging connector of the charger needs to be physically separated from the charging inlet of the vehicle by a user.

Some users accidentally drive the vehicle during the charging process where the charging connector is still coupled to the charging inlet. When the vehicle moves as far as or beyond the length of the cable of the charger, the tension between the charging inlet and the charging station is extremely tight, and then the coupling between the charging inlet and the charger or any random portions of the charging inlet and the charging station may be destructively separated while the electricity flows therethrough. This may result in mechanical and/or electrical damage in any of the vehicle and the charging station.

### SUMMARY

An embodiment of a system disclosed herein comprises a first support configured to hold a charging socket and including at least one first guide pin portion; a second support configured to rotatably hold the first support in a horizontal plane and allow the first support to rotate horizontally according to movement of the charging socket; and a switch positioned near at least one of the first support and the second supports, wherein the switch is configured to sense whether the first support rotates and switch the operation status of the charging socket when sensing the rotation of the first support. In one embodiment, a system comprises a first support configured to fixedly hold a charging socket; a second support configured to rotatably hold the first support in a horizontal plane and to rotate itself in a vertical plane; and a third support configured to rotatably hold the second support in the vertical plane, wherein at least one of the second support and the third support rotates, according to movement of the charging socket.

A system embodiment may include: a first support configured to hold a charging socket and including at least one first guide pin portion; a second support configured to rotatably hold the first support in a horizontal plane and allow the first support to rotate horizontally according to movement of the charging socket; and a switch positioned near at least one of the first support and the second supports, the switch configured to sense whether the first support rotates and switch the operation status of the charging socket when sensing the rotation of the first support.

In additional system embodiments, the switch may be electronically connected to a control pin of the charging socket, and where, when the switch senses the rotation of the first support, the switch changes the operation status from normally closed to normally open by electronically disconnecting the control pin.

In additional system embodiments, the first support includes at least one first guide pin portion, and where the second support includes at least one first slotted hole portion through which the first guide pin portion penetrates and may be configured to move along the path of the first slotted hole portion.

In additional system embodiments, each of the at least one first guide pin portion may be connected to at least one of the top and the bottom of the first support, where the second support includes at least one first plate, each of the at least one first plate positioned on the at least one of the top and the bottom of the first support, and where each of the at least one first plate includes the first slotted hole portion formed therethrough.

In additional system embodiments, the at least one first guide pin portion penetrates through the at least one first slotted hole portion and protrudes over a surface of the at least one first plate, and where the switch may be positioned on the surface of the at least one first plate and senses whether the first support rotates by detecting movement of the protruded portion of the at least one first guide pin portion over the surface.

In additional system embodiments, each of the at least one first guide pin portion includes at least one first guide pin, where each of at least one first slotted hole portion includes at least one first slotted hole corresponding to the at least one first guide pin, and where each of the at least one first slotted hole has an arc shape.

In additional system embodiments, the at least one first guide pin includes a plurality of first guide pins, and the at least one first slotted hole includes a plurality of first slotted holes corresponding to the plurality of first guide pins, and where the plurality of first slotted holes form portions of a circumference of a common imaginary circle, respectively.

In additional system embodiments, each of the at least one first plate further includes: a first fixed pin fixedly connected to the each of the at least one first plate; and a first spring positioned on the each of the at least one first plate such that two legs of the first spring may be positioned between the first fixed pin and one of at least one first guide pin.

In additional system embodiments, each of the at least one first guide pin portion further includes a first center pin, where each of at least one first slotted hole portion further includes a first center hole corresponding to the first center pin, and the first center hole has a circle shape that allows the first center pin to rotate according to movement of the charging socket, and where a helical portion of the first spring between the two legs may be mounted around the first center pin.

Additional system embodiments may include: a third support, where the second support further includes at least one second plate, each of the at least one second plate connected to the at least one side edge of the at least one first plate in a perpendicular direction to the at least one first plate, where the third support may be configured to rotatably hold the second support in a vertical plane from the at least one second plate, and where the first support rotates in at least one of the horizontal plane and the vertical plane according to movement of the charging socket.

In additional system embodiments, each of the at least one second plate of the second support includes at least one second guide pin portion, and where the third support includes at least one second slotted hole portion through which the second guide pin portion penetrates and may be configured to move along the path of the second slotted hole portion.

In additional system embodiments, the third support includes at least one third plate, each of the at least one third plate positioned on the at least one second plate, and where each of the at least one third plate includes the second slotted hole portion formed therethrough.

In additional system embodiments, each of the at least one second guide pin portion includes at least one second guide pin, where each of at least one second slotted hole portion includes at least one second slotted hole corresponding to the at least one second guide pin, and where each of the at least one second slotted hole has an arc shape.

In additional system embodiments, the at least one second guide pin includes a plurality of second guide pins, and the at least one second slotted hole includes a plurality of second slotted holes corresponding to the plurality of second guide pins, and where the plurality of second slotted holes form portions of a circumference of a common imaginary circle, respectively.

In additional system embodiments, each of the at least one third plate further includes: a second fixed pin fixedly connected to each of the at least one third plate, and a second spring positioned on each of the at least one third plate such that the second spring connects between one of the at least one second guide pin and the second fixed pin.

In additional system embodiments, the second slotted hole corresponding to the second guide pin connected to the second spring includes a first end where the second guide pin connected to the second spring may be positioned when the first support does not vertically rotate and a second end where the second guide pin connected to the second spring may be positioned when the first support vertically rotates, and where the second fixed pin may be positioned closer to the first end than the second end.

Another system embodiment may include: a first support configured to fixedly hold a charging socket; a second support configured to rotatably hold the first support in a horizontal plane and to rotate itself in a vertical plane; and a third support configured to rotatably hold the second support in the vertical plane, where at least one of the second support and the third support rotates, according to movement of the charging socket.

Additional system embodiments may further include: a switch, where the switch may be positioned near at least one of the first support and the second supports and configured to sense whether the first support rotates and switch the operation status of the charging socket when sensing the rotation of the first support.

In additional system embodiments, the switch may be electronically connected to a control pin of the charging socket, and where, when the switch senses the rotation of the first support, the switch changes the operation status from normally closed to normally open by electronically disconnecting the control pin.

Additional system embodiments may include: a bracket configured to hold the third support and to be connected to a vehicle.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1A illustrates a front top perspective view of an inlet system with a charging socket in a normal position, according to an embodiment of the disclosure herein;

FIG. 1B depicts a magnified view of a portion M1 of the inlet system in FIG. 1A, according to an embodiment of the disclosure;

FIG. 2A illustrates a rear bottom perspective view of an inlet system with a charging socket in a normal position, according to an embodiment of the disclosure;

FIG. 2B depicts a magnified view of a portion M2 of the inlet system in FIG. 2A in a normal position, according to an embodiment of the disclosure;

FIG. 3A illustrates a front top perspective view of an inlet system with a charging socket in a rotated position, according to an embodiment of the disclosure;

FIG. 3B depicts a magnified view of a portion M3 of the inlet system in FIG. 3A, according to an embodiment of the disclosure;

FIG. 4A depicts a portion of a bottom view of an inlet system with a charging socket in a normal position, which is viewed from a line A-A in FIG. 2A, according to an embodiment of the disclosure;

FIG. 4B depicts a portion of a bottom view of an inlet system with a charging socket in a rotated position, which is viewed from a line A-A in FIG. 2A, according to an embodiment of the disclosure;

FIG. 5A illustrates a circuit diagram of a reefer unit of an inlet system with a charging socket, according to an embodiment of the disclosure;

FIG. 5B illustrates a circuit diagram of a wall box unit of an inlet system with a charging socket, according to an embodiment of the disclosure;

FIG. 6 illustrates a front top perspective view of an inlet system with a charging socket in a normal position, according to an embodiment of the disclosure;

FIG. 7 illustrates a right side perspective view of an inlet system with a charging socket in a normal position, according to an embodiment of the disclosure;

FIG. 8 illustrates a left side perspective view of an inlet system with a charging socket in a normal position, according to an embodiment of the disclosure;

FIG. 9A illustrates a right side view of an inlet system with a charging socket in a normal position, which is viewed from a line B-B in FIG. 6, according to an embodiment of the disclosure;

FIG. 9B illustrates a right side view of an inlet system with a charging socket in a vertically rotated position, which is viewed from a line B-B in FIG. 6, according to an embodiment of the disclosure;

FIG. 10A illustrates a front top perspective view of an inlet system with a charging socket in a normal position, according to an embodiment of the disclosure; and

FIG. 10B illustrates a front top perspective view of an inlet system with a charging socket in a rotated position, according to an embodiment of the disclosure.

### DETAILED DESCRIPTION

The present disclosure provides an inlet system with a charging socket that is configured to rotate according to the movement of a vehicle and secure the safe electronical and mechanical disconnection from a charging connector, thereby providing safe connection for charging or power feeding the vehicle.

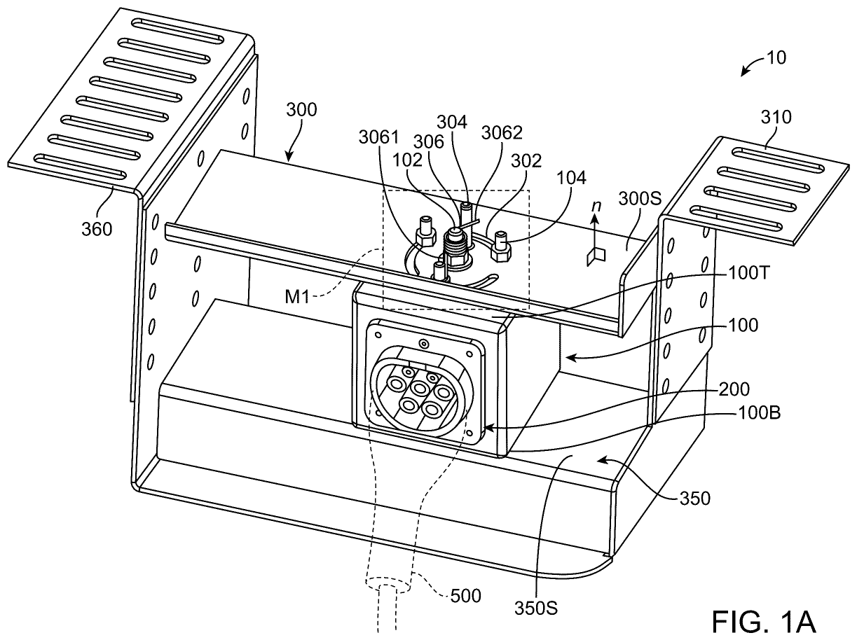

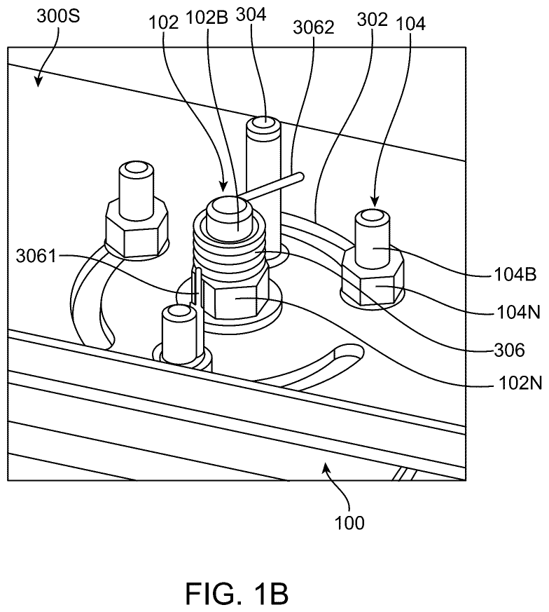

FIG. 1A illustrates a front top perspective view of an inlet system with a charging socket in a normal position, according to an embodiment of the disclosure. FIG. 1B depicts a magnified view of a portion M1 of the inlet system in FIG. 1A, according to an embodiment of the disclosure. Referring to FIGS. 1A and 1B, the inlet system 10 may comprise a first support 100 configured to hold a charging socket 200, second supports 300, 350 configured to rotatably hold the first support 100, and a set of brackets 310, 360 connected to both sides of the second supports 300, 350. The inlet system 10 may be mounted on an electric vehicle or a transport unit connected to a vehicle, which requires electric charge or power feeding, and be supplied with electricity through a charging connector 500 connecting between the inlet system 100 and an external power source.

The first support 100 may have a structure that is configured to fixedly hold the charging socket 200 while revealing the front of the charging socket 200 to the outside, allowing the charging connector 500 to be coupled to the charging socket 200. As shown in FIGS. 1A and 1B, the first support 100 may have a hexahedron shape but is not limited thereto.

The charging socket 200 contained in the first support 100 may be configured to be mechanically, electrically coupled to the charging connector 500 and supplied with electricity therethrough. In some embodiments, the charging socket 200 may be an IEC 62196 type 2 charging socket but is not limited thereto. The supplied electricity through the charging socket 200 may be transferred to the electric motor of a vehicle or a transport unit connected to a vehicle. In some embodiments, the vehicle may be any kind of electric vehicle including a car, a bus, a train, a truck, a personal vehicle, a vehicle with a trailer, and others, and the inlet system 10 may be used to provide safe connection to an electric motor of the vehicle. In some embodiments, the inlet system 10 may be used to provide safe connection to an electric motor of a transport unit connected to a vehicle. In some embodiments, the inlet system 10 may be installed at a trailer or a transport unit of the vehicle, such as Transport Refrigeration Units (TRU), or reefer, and may be used to provide safe connection to an electric motor of the TRU.

The first support 100 may comprise a first pin portion including at least one pin, which are fixedly connected to the top 100T of the first support 100. In the embodiment shown in FIGS. 1A and 1B, the first pin portion of the first support 100 may include a first center pin 102 and a first guide pin portion 104 surrounding the first center pin 102. The first guide pin portion 104 may include three first guide pins 104 positioned apart from the first center pin 102 by the same distance.

The second supports 300, 350 may be configured to rotatably hold the first support 100 from the top 100T and the bottom 100B of the first support 100, respectively. Specifically, the second supports 300, 350 may include two plates 300, 350 that are respectively positioned on the top 100T and the bottom 100B of the first support 100 and hold the first support 100 from the top 100T and the bottom 100B, allowing the horizontal rotation of the first support 100. In the embodiment shown in FIGS. 1A and 1B, the first support 100 may be held by two supports of the second supports 300, 350, but the present disclosure is not limited thereto. In other embodiments, the first support 100 may be held by a single support, such as any one of the second supports 300, 350, or more than two supports.

The top plate 300 of the second supports 300, 350 positioned on the top 100T may include a first slotted hole portion 302, a first fixed pin 304 fixedly connected to the top of the main surface 300S of the top plate 300, and a first torsion spring 306 positioned above the main surface 300S.

The first slotted hole portion 302 may include at least one first slotted hole 302 that respectively correspond to the first center pin 102 and the first guide pins 104 of the first support 100. In the embodiment shown in FIGS. 1A and 1B, the slotted hole portion 302 may include a first center hole (not shown) having a circle shape that allows the first center pin 102 rotates. The first center pin 102 of the first support 100 may penetrate the circle shape of the first center hole, and the three first guide pins 104 of the first support 100 may penetrate the three first slotted holes 302. The penetrated first center pin 102 and first guide pins 104 of the first support 100 may protrude above the main surface 300S of the top plate 300 of the second support 300, 350, penetrating through the first center hole and the first slotted holes 302.

Each of the three first slotted holes 302 may have an arc shape, which respectively forms a portion of a circumference of a common imaginary circle having a center at the first center hole. Each of the first slotted holes 302 may have a limited length, and in some embodiments, may not exceed one third of the circumference of the common imaginary circle. The first guide pins 104, which are fixed to the first support 100 and penetrate the first slotted holes 302, may be configured to move along the path of the arc-shaped first slotted hole portion 302 according to the horizontal rotation of the first support 100. In other words, as the first support 100 rotates in a horizontal plane parallel to the main surface 300S around a vertical axis parallel to the normal vector n of the main surface 300S, the first guide pins 104 fixedly connected to the first support 100 may also rotate along the arc-shaped first slotted holes 302. Then, when the first guide pins 104 reach to the end of the first slotted holes 302, the end of the first slotted holes 302 may act as a stopper, or a rotation limit, to the first guide pins 104 and stop the rotation of the first support 100.

The first torsion spring 306 may be mounted around the first center pin 102 protruding above the main surface 300S and configured to maintain the first support 100 in a normal position in a horizontal plane. Specifically, a first leg 3061 and a second leg 3062 of the first torsion spring 306 may be positioned between one of the first guide pins 104 of the first support 100 and the first fixed pin 304 of the second support 300, respectively. The helical portion of the first torsion spring 306 between the first leg 3061 and a second leg 3062 may be inserted around the first center pin 102 to surround the first center pin 102. In some embodiments, the first fixed pin 304 may be positioned closer to the first center pin 102 than the distance each of the first guide pins 104 is positioned from the first center pin 102 but is not limited thereto.

When there is an external force to horizontally rotate the first support 100, the first guide pin 104 connected to the first support 100 may move a little along the first slotted hole 302, and the first leg 3061 positioned in the path of the first slotted hole 302 may also move a little with the first guide pin 104 along the first slotted hole 302, twisting the first torsion spring 306 along its axis. The axis of the first torsion spring 306 may be parallel to the normal vector n of the main surface 300S. When the first torsion spring 306 is twisted, the first torsion spring 306 may exert a torque propositional to the degree that the first torsion spring 306 is twisted in the opposite direction and move the first leg 3061 back to the normal position if there is no persistent external force. Thus, the first torsion spring 306 may maintain the first support 100 in a normal position against intermittent and weak external forces. The first torsion spring 306 may act as a buffer against an intermittent and weak external force, thereby providing safe mechanical and electrical connection between the inlet system 10 and the charging connector 500.

The set of brackets 310, 360 may be configured to hold the second supports 300, 350 from both sides of the second supports 300, 350. The brackets 310, 360 may include a plurality of slots to adjust the mounting position of the brackets 310, 360. The inlet system 10 may be installed on a vehicle or a transport unit connected to a vehicle, by using the slots of the brackets 310, 360 and fastening means through the slots. In some embodiments, the inlet system 10 may be installed under a vehicle or a transport unit connected to a vehicle but is not limited thereto. The inlet system 10 may be installed in any desired locations of a vehicle or a transport unit connected to a vehicle.

In some embodiments, the first support 100, the second support 300, and the brackets 310, 360 of the inlet system 10 may be made of metal to endure the harsh environment. For example, when the inlet system 10 is installed under a vehicle or a transport unit, such as under a trailer, the inlet system 10 may be hit by rocks thrown from the roadway or other cars. In this case, the metal material may be useful to protect the inlet system 100. In some embodiments, the first support 100, the second support 300, and the brackets 310, 360 may be a welded metal structure, or in other embodiments, each of the first support 100, the second support 300, and the brackets 310, 360 may be connected to each other via fastening means, such as bolt and nut, etc. The system 10 may be mounted on or connected to a vehicle using the brackets 310, 360.

Referring to FIG. 1B, the first center pin 102 may include a bolt portion 102B and a nut portion 102N engaged with the bolt portion 102B protruding above the main surface 300S of the second support 300. The external width of the nut portion 102N may be wider than the diameter of the first center hole (not shown) of the second support 300, and thus, the nut portion 102N may prevent the vertical movement, or axial movement, of the bolt portion 102B, while allowing the rotation of the bolt portion 102B in the first center hole. Likewise, each of the first guide pins 104 may also include a bolt portion 104B and a nut portion 104N engaged with the bolt portion 104B protruding above the main surface 300S. The external width of the nut portion 104N may be wider than the width of the first slotted hole 302, which is perpendicular to the path of the first slotted hole 302, and thus, the nut portion 104N may prevent the vertical movement, or axial movement, of the bolt portion 104B, while allowing the movement of the bolt portion 102B along the first slotted hole 302.

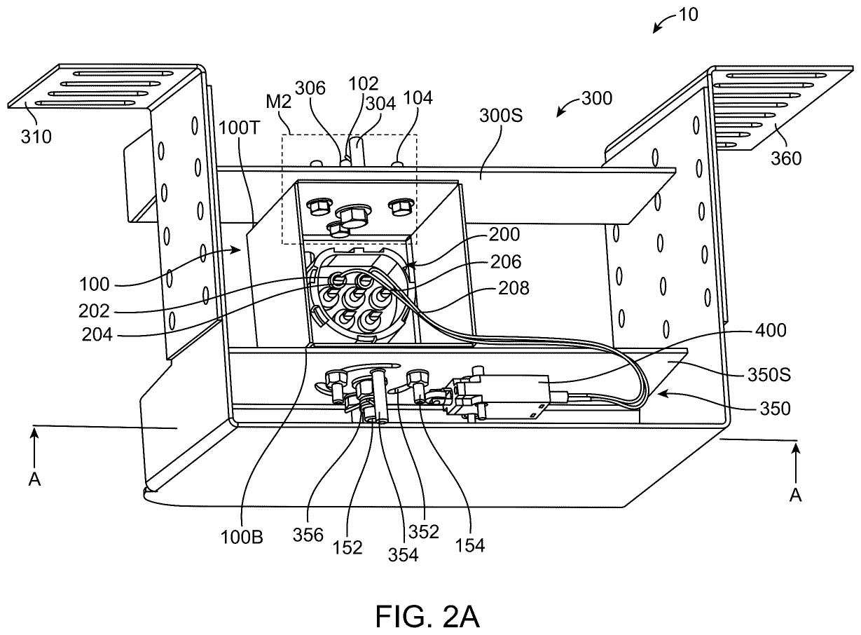

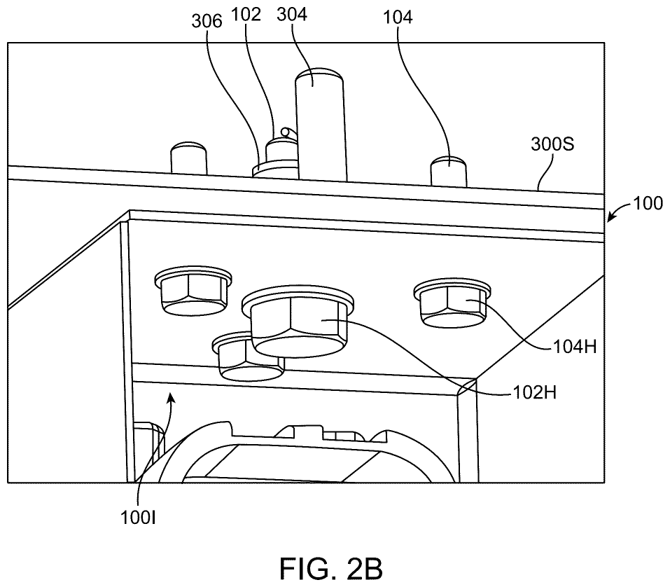

FIG. 2A illustrates a rear bottom perspective view of an inlet system with a charging socket in a normal position, according to an embodiment of the disclosure. FIG. 2B depicts a magnified view of a portion M2 of the inlet system in FIG. 2A in a normal position, according to an embodiment of the disclosure. The embodiment shown in FIGS. 2A and 2B may be a rear bottom perspective view of the inlet system 10 described above referring to FIGS. 1A and 1B. Referring to FIG. 2A, the inlet system 10 may comprise the first support 100, the second supports 300, 350, the set of brackets 310, 360, and a switch 400 configured to change its operation status by sensing the rotation of the first support 100.

The portion of the back of the first support 100 may include an opening through which wires 206, 208 from the charging socket 500 may be extended. Specifically, the charging socket 200 may include a plurality of pins, including control pins 202, 204, such as a control pilot (CP) and a proximity pilot (PP), and a plurality of wires connected to these pins. The plurality of wires may include wires 206, 208 connected between the control pins 202, 204 and the switch 400. Other wires may also be connected to the remaining pins but omitted in FIG. 2A.

The first pin portion of the first support 100 may be formed on the top 100T of the first support 100 as described in FIGS. 1A and 1B, and a second pin portion may be formed on the bottom 100B of the first support 100. Similar to the first pin portion formed on the top 100T, the second pin portion may include at least one pin, which are fixedly connected to the bottom 100B. The second pin portion of the first support 100 may include a second center pin 152 and a second guide pin portion 154 surrounding the second center pin 152. In this case, the second center pin 152 may be positioned to have the same axis as the first center pin 102. The second guide pin portion 152 may include three second guide pins 152 positioned apart from the second center pin 152 by the same distance.

The second supports 300, 350 may be configured to rotatably hold the first support 100 from the top 100T and the bottom 100B of the first support 100, respectively. Like the second support 300 on the top 100T, a bottom plate 350 of the second support 350 on the bottom 100B may also include a second slotted hole portion 352, a second fixed pin 354 fixedly connected to the bottom of a main surface 350S of the bottom plate 350, and a second torsion spring 356 positioned below the main surface 350S.

The second slotted hole portion 352 may include at least one second slotted hole 352 that respectively correspond to the second center pin 152 and the second guide pins 154 of the first support 100. The second slotted hole portion 352 may include a second center hole (not shown), through which the second center pin 152 of the first support 100 penetrates, and three second slotted holes 352, through which the three second guide pins 154 of the first support 100 penetrate, respectively. The penetrated second center pin 152 and second guide pins 154 of the first support 100 may protrude under the main surface 350S of the second support 350, penetrating through the second center hole and the second slotted holes 352.

Each of the three second slotted holes 352 may have an arc shape and may have the same shape and function as the first slotted holes 302. According to the horizontal rotation of the first support 100, the second guide pins 154, which are fixed to the bottom 100B of the first support 100 and penetrate the second slotted holes 352, may be configured to move along the path of the arc-shaped second slotted hole portion 352 like the first guide pins 104.

The second torsion spring 356 may be mounted around the second center pin 152 protruding below the main surface 350S and configured to maintain the first support 100 in a normal position in a horizontal plane along with the first torsion spring 306. The detailed position and function of the second torsion spring 356 may be similar to the first torsion spring 306. The first and the second torsion spring 306, 356 on the top 100T and the bottom 100B of the first support 100 can maintain the first support 100 in a normal position in more stable manner, thereby providing safer mechanical and electrical connection between the inlet system 10 and the charging connector 500.

The switch 400 may be positioned near at least one of the first support 100 and the second supports 300, 350 and configured to change the operation status of the charging socket 200 when it senses that the first support 100 starts to rotate. Specifically, in the embodiment shown in FIG. 2A, the switch 400 may be positioned underneath the second support 350 near the second guide pins 154 and sense the rotation of the first support 100 by sensing the movement of the second guide pins 154. When the first support 100 containing the charging socket 200 starts to rotate, the first guide pins 104 and the second guide pins 254, which are connected to the first support 100, also start to rotate along the first slotted holes (302, FIG. 1A) and the second slotted holes 352. The switch 400 near the second guide pins 254 may detect this starting moment of the rotation of the second guide pins 154 by using a mechanical means or a magnetic means, such as a reed switch. The reed switch may be actuated by the change of magnetic field.

Once the switch 400 senses the initial moment of the rotation of the first support 100, the switch 400 may change its operation status from normally closed to normally open at the moment of the rotation of the first support 100. The status change of the switch 400 may electronically disconnect the control pins 202, 204 of the charging socket 200 through the wires 206, 208 before the charging connector (500, FIG. 1A) is pulled out from the charging socket 200. Accordingly, when the vehicle accidentally starts to drive without separating the charging connector (500, FIG. 1A) from the inlet system 10, the inlet system 10 may perform proactive electronical disconnection between the charging connector (500, FIG. 1A) and the inlet system 10, thereby preventing electronic damages on the charging connector (500, FIG. 1A) and the inlet system 10. In addition, the rotation of the first support 100 may allow the charging socket 200 to face toward a pulling force of the charging connector (500, FIG. 1A), thereby preventing mechanical damage that may occur by destructive disconnection between the charging connector (500, FIG. 1A) and the inlet system 10. Thus, the inlet system 100 may secure safe electricity supply to a vehicle or a transport unit connected to a vehicle.

The sensitivity for the change of operation status of the switch 400 may be determined by an operator of the inlet system 10. In some embodiments, the switch 400 may open immediately when it detects the rotation, or in other embodiments, the switch 400 may open after a certain time period of delay.

In the embodiment shown in FIG. 2A, the switch 400 is positioned underneath the second support 350 under the bottom 100B of the first support 100, but the position of the switch 400 is not limited thereto. In some embodiments, the switch 400 may be positioned on the second support 300 on the top 100T of the first support 100 or any location in the inlet system 10. In some embodiments, the switch 400 may sense the rotation of the first support 100 by sensing the movement of a part of the rotating first support 100, such as a tab.

Referring to FIGS. 1B and 2B, the connection between the first support 100 and each of the first pin portion on the top 100T and the second pin portion on the bottom 100B may be formed by bolts and nuts in some embodiments. Each of the first center pin 102 and the first guide pins 104 may include a head portion 102H, 104H, a bolt portion 102B, 104B, and a nut portion 102N, 104N. The head portion 102H, 104H, which has the wider width of a hole (not shown) of the first support 100, may be positioned inside the first support 100 such that the bolt portion 102B, 104B connected to the head portion 102H, 104H may penetrate through the hole of the first support 100 and the center hole and the slotted holes 302 of the second support 200 and be engaged with the nut portion 102N, 104N on the main surface 300S of the second support 300. Likewise, each of the second center pin 152 and the second guide pins 154 shown in FIG. 2A may be connected to the first support 100 in the same manner used in the connection between the first support 100 and each of the first center pin 102 and the first guide pins 104.

FIGS. 1A to 2B illustrate that the first support 100 includes two first guide pin portions 102, 152 respectively formed on the top 100T and the bottom 100B, but the present disclosure is not limited thereto. In some embodiments, the first support 100 may include a single guide pin portion 102 on any one of the top 100T and the bottom 100B thereof.

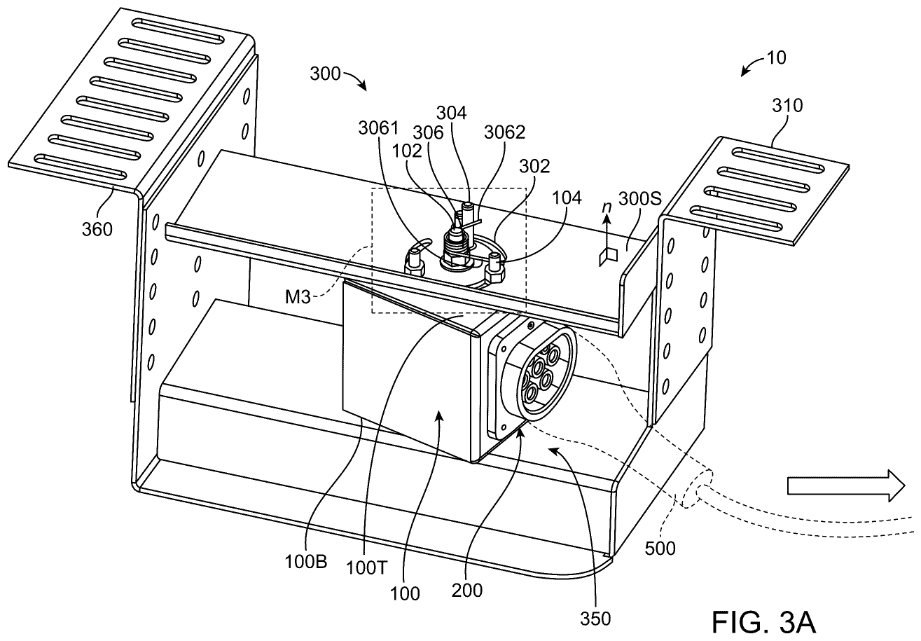

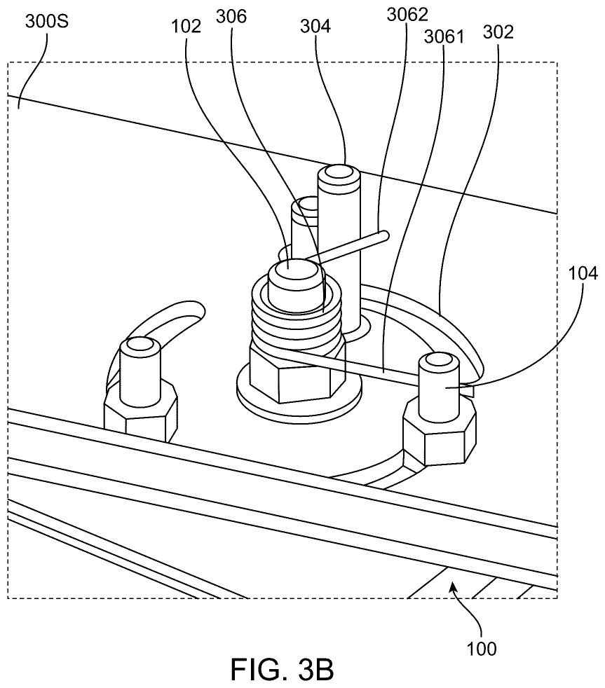

FIG. 3A illustrates a front top perspective view of an inlet system with a charging socket in a rotated position, according to an embodiment of the disclosure. FIG. 3B depicts a magnified view of a portion M3 of the inlet system in FIG. 3A, according to an embodiment of the disclosure. The embodiment shown in FIGS. 3A and 3B may be a front top perspective view of the inlet system 10 described above referring to FIGS. 1A to 2B. Referring to FIG. 1A again, the charging connector 500 of a charger may be connected to the charging socket 200 in the normal position for charging a vehicle or a transport unit of a vehicle, and a charging plug of the charger may be connected an external power source. In this normal position, the front of charging socket 200 may be positioned to be parallel to the front edge of the second support 300 and the side of the vehicle or the transport unit of the vehicle on which the inlet system 10 is mounted. After completing the charging process, a user may disconnect the charging connector 500 from the charging socket 200 in the normal position.

In some cases, referring to FIGS. 3A and 3B, a user may accidentally start to drive the vehicle without separating the charging connector 500 from the charging socket 200 while the charging is still in progress. If the vehicle starts to move, for example, toward the left side, the charging cable connecting between the charging connector 500 and the external power source fixed at a certain location may become tense and be pulled to the right side. Accordingly, the first support 100 containing the charging socket 200, which is connected to the charging connector 500, starts to rotate counterclockwise and be oriented toward the external power source to which the cable is connected due to a persistent pulling force to the right side. Since the pulling force caused by the driving of vehicle is strong and persistent, the first torsion spring 306 and the second torsion spring (356, FIG. 2A) may no longer maintain the normal position of the first support 100 and may allow the rotation of the first support 100. As shown in FIG. 3B, according to the rotation of the first support 100, the first leg 3061 of the first torsion spring 306 may twist along its axis by the first guide pin 104, which moves along the first slotted hole 302. The first torsion spring 306 may store the torsional energy when it is twisted. The second torsion spring (356, FIG. 2A) may also be twisted according to the rotation of the first support 100.

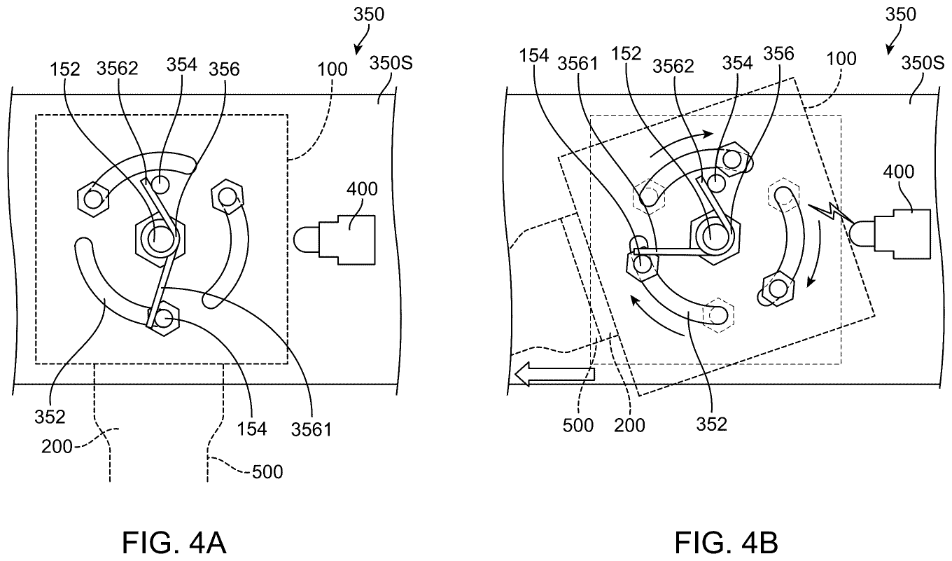

FIG. 4A depicts a portion of a bottom view of an inlet system with a charging socket in a normal position, which is viewed from a line A-A in FIG. 2A, according to an embodiment of the disclosure. FIG. 4B depicts a portion of a bottom view of an inlet system with a charging socket in a rotated position, which is viewed from a line A-A in FIG. 2A, according to an embodiment of the disclosure. The embodiment shown in FIGS. 4A and 4B may be a portion of a bottom view of the inlet system 10 described above referring to FIGS. 1A to 3B. Referring to FIG. 4A, in the normal position, the charging connector 500 may be connected to the charging socket 200 in a state where the front of the charging socket 200 is positioned parallel to the front edge of the second support 350. There is no rotation of the first support 100, the charging socket 200, and the second guide pins 154 and no twist of the second torsion spring 356. The switch 400 may maintain the normally closed status for the electronic connection between the charging connector 500 and the charging socket 200.

When the vehicle moves, referring to FIG. 4B, the charging connector 500 may be pulled to the opposite direction. Accordingly, the first support 100 containing the charging socket 200 starts to rotate. The second torsion spring 356 may no longer maintain the normal position of the first support 100 and may allow the rotation of first support 100. At the moment of the rotation of the first support 100, the switch 400 may change its operation status from normally closed to normally open. Accordingly, the electronic connection between the charging connector 500 and the charging socket 200 is disconnected before the connection between the charging connector 500 and the charging socket 200 is physically disconnected. Thus, the charging socket 200 and the charging connector 500 can be protected from any damage caused by flowing electricity even though the charging connector 500 is physically disconnected from the charging socket 200 due to a persistent pulling force by a vehicle.

In addition, the charging connector 500 may be pulled out from the charging socket 200 in the rotated position of the charging socket 200 and the first support 100 when the vehicle keeps moving. Since the fronts of the charging socket 200 and the first support 100 are rotated to face toward the direction of the pulling force of the charging connector 500, the charging connector 500 can be pulled out from the charging socket 200 without any damages caused by an excessive angle formed between the front of the charging socket 200 and the pulling direction of the charging connector 500. If there is an excessive angle between the front of the charging socket 200 and the pulling direction of the charging connector 500, the pins of the charging socket 200 and/or the charging connector 500 may be bent, or any portions of the charging socket 200, the charging connector 500, and/or a cable connected to the charging connector 500 may be mechanically damaged.

Thus, the inlet system of the present disclosure can provide safe connection for charging a vehicle or a transport unit of a vehicle by securing the safe electronical and mechanical disconnection between the inlet system 10 and the charging connector 500. Additionally, while the inlet system 10 is in the rotated position, the first torsion spring (306, FIGS. 1A to 3B) and the second torsion spring 356 may store the torsional energy. Once the charging connector 500 is pulled out from the charging socket 200, the first support 100 can move back and restore its normal position by this torsional energy without any manual control. Thus, the inlet system 10 can provide additional convenience to a user.

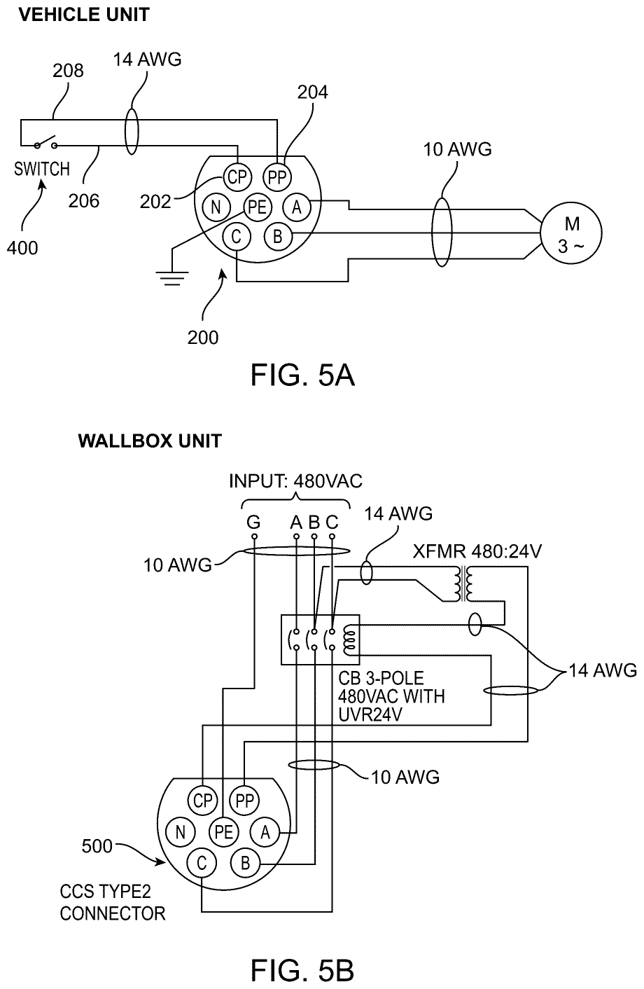

FIG. 5A illustrates a circuit diagram of a vehicle unit of an inlet system with a charging socket, according to an embodiment of the disclosure. FIG. 5B illustrates a circuit diagram of a wall box unit, according to an embodiment of the disclosure. Referring to FIG. 5A, a vehicle unit may include an inlet system of the present disclosure. A charging socket 200 may be an IEC 62196 type 2 charging socket but is not limited thereto. As described above in FIG. 2A, control pins 202, 204 may be connected to a switch 400 via wires 206, 208. When the switch 400 senses the rotation of a first support (100, FIG. 1A) containing the charging socket 200, the switch 400 changes its status from normally closed to normally open and electronically disconnects the control pins 202, 204. In some embodiments, the switch 400 may be Single-Pole Single-Throw (SPST) but is not limited thereto. The charging socket 200 may be connected to an electric motor of a vehicle or a transport unit connected to a vehicle. The electric motor may be a 3-phase motor.

Referring to FIG. 5B, a wall box unit may include a charging connector 500 and an external power source. When the charging connector 500 is connected to the charging socket 200, the external power source of the wall box unit may supply electricity to the vehicle unit. The charging connector 500 may be an IEC 62196 type 2 charging connector but is not limited thereto.

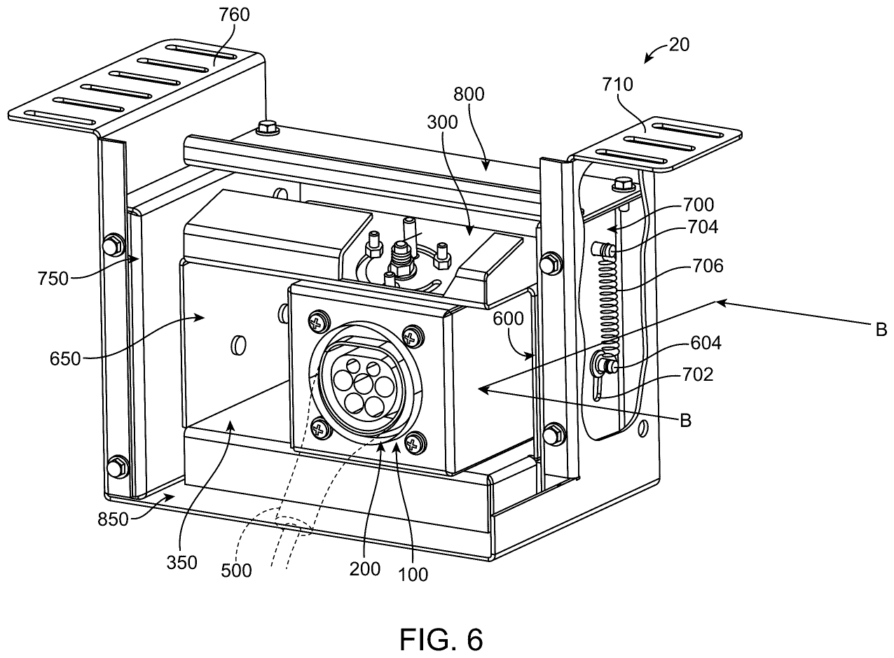

FIG. 6 illustrates a front top perspective view of an inlet system with a charging socket in a normal position, according to an embodiment of the disclosure. A portion of the inlet system is ripped off to show the internal components thereof. The inlet system 20 shown in FIG. 6 may further allow the vertical rotation of a charging socket 200 in addition to the horizontal rotation of the charging socket 200. The same reference numerals indicate the same components, and the detailed descriptions for those same components will be omitted. Referring to FIG. 6, the inlet system 20 may comprise a first support 100 configured to hold a charging socket 200, second supports 300, 350, 600, 650 configured to rotatably hold the first support 100 in a horizontal plane, third supports 700, 750 configured to rotatably hold the second supports 300, 350, 600, 650 in a vertical plane, and a set of brackets 710, 760 connected to both sides of the third supports 700, 750. The inlet system 20 may be mounted on an electric vehicle or a transport unit connected to a vehicle, which requires electric charge. The structure and mechanism for the horizontal rotation of the first support 100 are the same as those in the inlet system 10 described above in FIGS. 1A to 4B.

The second support 300, 350, 600, 650 may include a top plate 300 and a bottom plate 350, which rotatably hold the first support 100 from the top 100T and the bottom 100B, and further include side plates 600, 650 connecting between the top plate 300 and the bottom plate 350 at the both side edges of the top plate 300 and the bottom plate 350 in a perpendicular direction to the top plate 300 and the bottom plate 350. Accordingly, the second support 300, 350, 600, 650 may have a hexahedron shape.

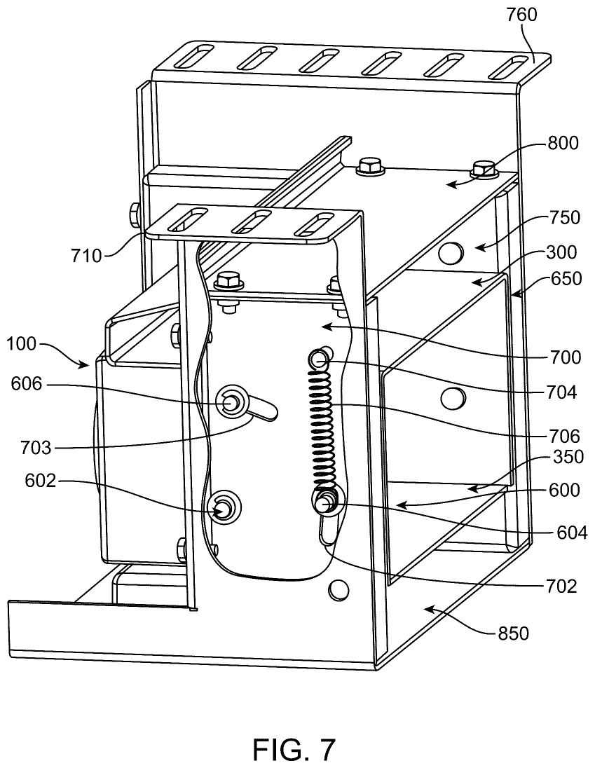

The third supports 700, 750 may be configured to rotatably hold the second support 300, 350, 600, 650 in a vertical plane from both side plates 600, 650 of the second support 300, 350, 600, 650. The third supports 700, 750 may include side plates 700, 750 that are respectively positioned on the side plates 600, 650 of the second support 300, 350, 600, 650 and may allow the vertical rotation of the second support 300, 350, 600, 650 in a similar structure and mechanism applied in the horizontal rotation of the first support 100, by using at least one pin 604, 704, at least one slotted hole 702, and a spring 706. The detailed description for the vertical rotation will be described referring to FIG. 7.

The set of brackets 710, 760 may be configured to hold the third supports 700, 750 from both sides of the third supports 700, 750. The brackets 710, 760 may include a plurality of slots to adjust the mounting position of the brackets 710, 760. The system 20 may be mounted on or connected to a vehicle using the brackets 710, 760.

In some embodiments, the inlet system 20 may further comprise additional supports including a top support 800 connecting between the top edges of the third supports 700, 750 and a bottom support 850 connecting between the bottom edges of the third supports 700, 750. These additional supports 800, 850 may add stability of the inlet system 20.

FIG. 7 illustrates a right side perspective view of an inlet system with a charging socket in a normal position, according to an embodiment of the disclosure. A portion of the inlet system is ripped off to show the internal components thereof. The embodiment shown in FIG. 7 may be a right side perspective view of the inlet system 20 described above referring to FIG. 6. Referring to FIGS. 6 and 7, the right side plate 600 of the second support 300, 350, 600, 650 may include a pivoting pin 602 and guide pins 604, 606, which are fixedly connected to the outer surface of the right side plate 600 of the second support 300, 350, 600, 650. The guide pins 604, 606 may be positioned apart from the pivoting pin 602 by the same distance.

The right side plate 700 of the third supports 700, 750 may comprise a slotted hole portion including slotted holes 702, 703, a fixed pin 704 fixedly connected to the outer surface of the right side plate 700, and a spring 706 positioned on the outer surface of the right side plate 700.

The slotted hole portion of the right side plate 700 may include a pivoting hole (not shown), through which the pivoting pin 602 of the second support 300, 350, 600, 650 penetrates, and two slotted holes 702, 703, through which the two guide pins 604, 606 of the second support 300, 350, 600, 650 penetrate, respectively. The penetrated pivoting pin 602 and guide pins 604, 606 of the second support 300, 350, 600, 650 may protrude above the outer surface of the right side plate 700, penetrating through the pivoting hole and the slotted holes 702, 703.

Each of the two slotted holes 702, 703 may have an arc shape, which respectively forms a portion of a circumference of a common imaginary circle having a center at the pivoting hole. In this case, each of the two slotted holes 702, 703 may have a limited length. The guide pins 604, 606, which are fixed to the second support 300, 350, 600, 650 and penetrate the two slotted holes 702, 703, may be configured to move along the path of the arc-shaped slotted hole holes 702, 703 according to the vertical rotation of the second support 300, 350, 600, 650 around the pivoting pin 602. In other words, as the second support 300, 350, 600, 650 rotates in a vertical plane parallel to the third supports 700, 750 around a horizontal axis parallel to the normal vector of the surfaces of third supports 700, 750, the guide pins 604, 606 fixedly connected to the second support 300, 350, 600, 650 may also rotate along the arc-shaped slotted holes 702, 703. Then, when the guide pins 604, 606 reach to the end of the slotted holes 702, 703, the end of the slotted holes 702, 703 may act as a stopper, or a rotation limit, to the guide pins 604, 606 and stop the rotation of the second support 300, 350, 600, 650.

The spring 706 may connect between one of the guide pins 604, 606 and the fixed pin 704 and be configured to maintain the second support 300, 350, 600, 650 in a normal position in a vertical plane. Specifically, one end of the spring 706 may be connected to one guide pin 604, and the other end may be connected to the fixed pin 704, respectively. Meanwhile, the second slotted hole 702 corresponding to the second guide pin 604 connected to the spring 706 may include a first end where the second guide pin 604 connected to the spring 706 is positioned when the first support 100 does not vertically rotate and a second end where the second guide pin 604 connected to the spring 706 is positioned when the first support 100 vertically rotates. In this case, the second fixed pin 704 may be positioned closer to the first end than the second end.

When there is an external force to vertically rotate the second support 300, 350, 600, 650, the guide pins 604, 606 connected to the second support 300, 350, 600, 650 may move along the slotted holes 702, 703, and the spring 706 connected to the guide pin 604 may resist stretching caused by the movement of the guide pin 604. When the second guide pin 604 connected to the spring 706 moves from the first end to the second end along the second slotted hole 702, stretching the spring 706, the spring 706 may exert a restoring force propositional to the degree that the spring 706 is stretched in the opposite direction and move the guide pin 604 back to the normal position if there is no persistent external force. Thus, the spring 706 may maintain the second support 300, 350, 600, 650 in a normal position against intermittent and weak external forces. In addition to torsion springs (306, 356, FIGS. 1A to 4B), which maintain the charging socket 200 in a normal position in a horizontal direction, the spring 706 may act as a buffer against an intermittent and weak external force in a vertical direction and maintain the charging socket 200 in a normal position in a vertical direction, thereby providing safe mechanical and electrical connection between the inlet system 20 and the charging connector 500.

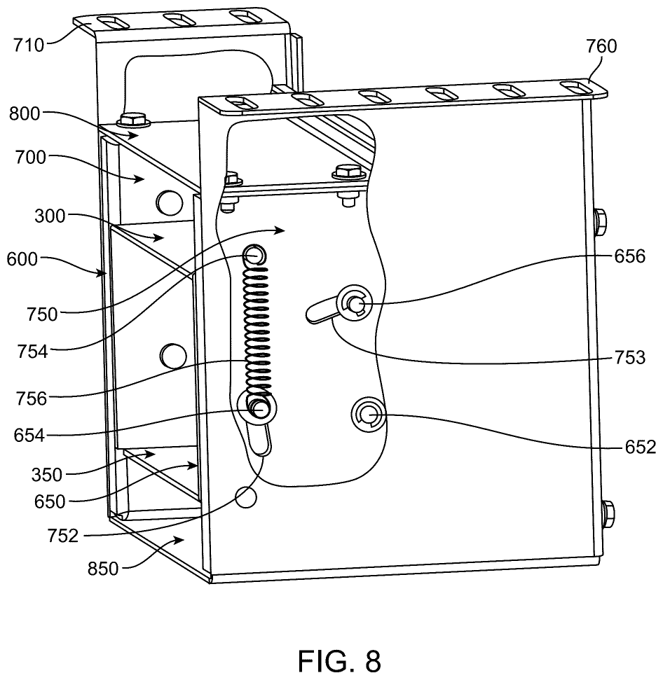

FIG. 8 illustrates a left side perspective view of an inlet system with a charging socket in a normal position, according to an embodiment of the disclosure. A portion of the inlet system is ripped off to show the internal components thereof. The embodiment shown in FIG. 8 may be a left side perspective view of the inlet system 20 described above referring to FIG. 7. The left side of the inlet system 20 in FIG. 8 may have the same structure and mechanism as the right side of the inlet system 20 shown in FIG. 7. Referring to FIG. 8, the left side plate 650 of the second support 300, 350, 600, 650 may include a pivoting pin 652 and guide pins 654, 656, which are fixedly connected to the outer surface of the left side plate 650 of the second support 300, 350, 600, 650.

The left side plate 750 of the third supports 700, 750 may comprise a slotted hole portion including slotted holes 752, 753, a fixed pin 754 fixedly connected to the outer surface of the left side plate 750, and a spring 756 positioned on the outer surface of the left side plate 750.

The slotted hole portion may include a pivoting hole (not shown), through which the pivoting pin 652 penetrates, and two slotted holes 752, 753, through which the two guide pins 654, 656 penetrate, respectively. The penetrated pivoting pin 652 and guide pins 654, 656 may protrude above the outer surface of the left side plate 750, penetrating through the pivoting hole and the slotted holes 752, 753. Each of the two slotted holes 752, 753 may have an arc shape with a limited length. The guide pins 654, 656 may be configured to move along the path of the arc-shaped slotted hole holes 752, 753 according to the vertical rotation of the second support 300, 350, 600, 650 around the pivoting pin 652.

The spring 756 may connect between one of the guide pins 654, 656 and the fixed pin 754 and be configured to maintain the second support 300, 350, 600, 650 in a normal position in a vertical plane. The two springs 706, 756 at both sides of the second support 300, 350, 600, 650 may maintain the normal position of the second support 300, 350, 600, 650 in a more stable manner.

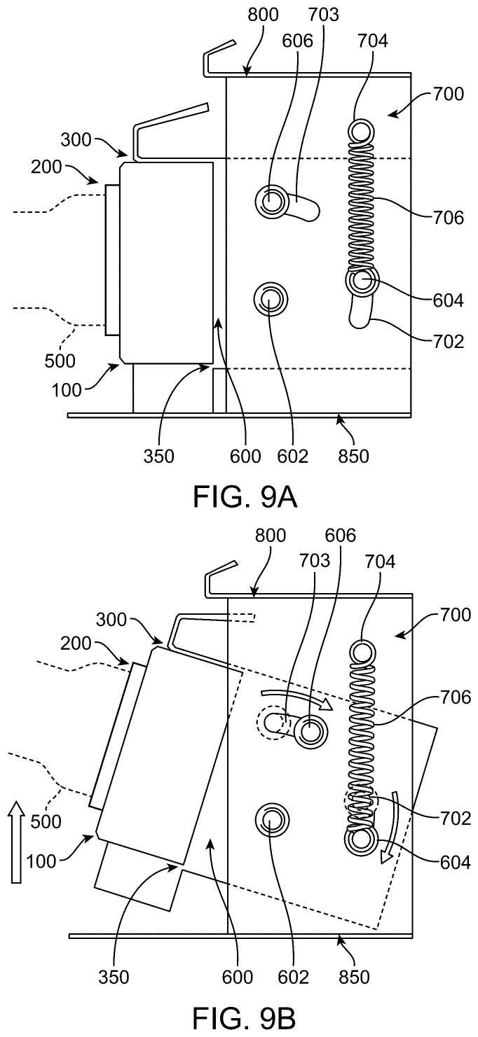

FIG. 9A illustrates a right side view of an inlet system with a charging socket in a normal position, which is viewed from a line B-B in FIG. 6, according to an embodiment of the disclosure. FIG. 9B illustrates a right side view of an inlet system with a charging socket in a vertically rotated position, which is viewed from a line B-B in FIG. 6, according to an embodiment of the disclosure. The embodiment shown in FIGS. 9A and 9B may be a right side view of the inlet system 20 described above referring to FIGS. 6 to 8. Referring to FIG. 9A, the charging connector 500 of a charger may be connected to the charging socket 200 in the normal position. In this normal position, the front of charging socket 200 may be positioned to be parallel to the front edges of the third support 700 and the side of a vehicle or a transport unit of a vehicle on which the inlet system 20 is mounted. After completing the charging process, a user may disconnect the charging connector 500 from the charging socket 200 in the normal position.

In some cases, the equipment of an external power source, such as a wall box, to which the charging cable is connected may be positioned on a higher level than the inlet system 20. In this case, referring to FIG. 9B, when the vehicle starts to move without separating the charging connector 500 from the charging socket 200, the charging cable connecting between the charging connector 500 and the external power source may be pulled upward. Accordingly, the second support 300, 350, 600, 650 holding the first support 100 that contains the charging socket 200, which is connected to the charging connector 500, starts to rotate upward around the pivot pin 602 and be oriented toward the charging cable which is connected to the equipment of the external power source on the higher level. According to the vertical rotation, the guide pins 604, 606 may move along the slotted holes 702, 703, respectively, and the spring 706 connected to the guide pin 604 may be stretched and store a potential energy when it is stretched.

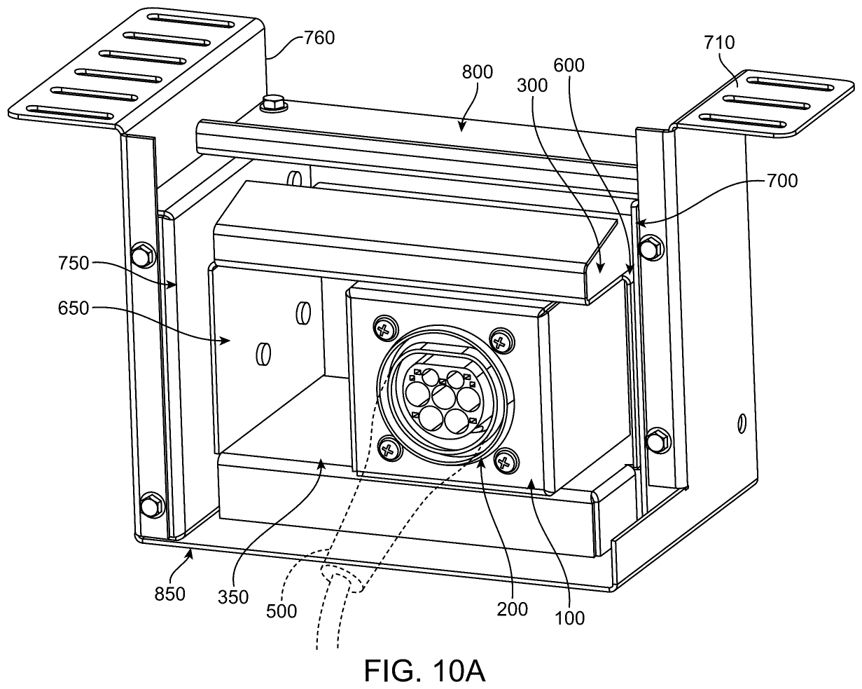

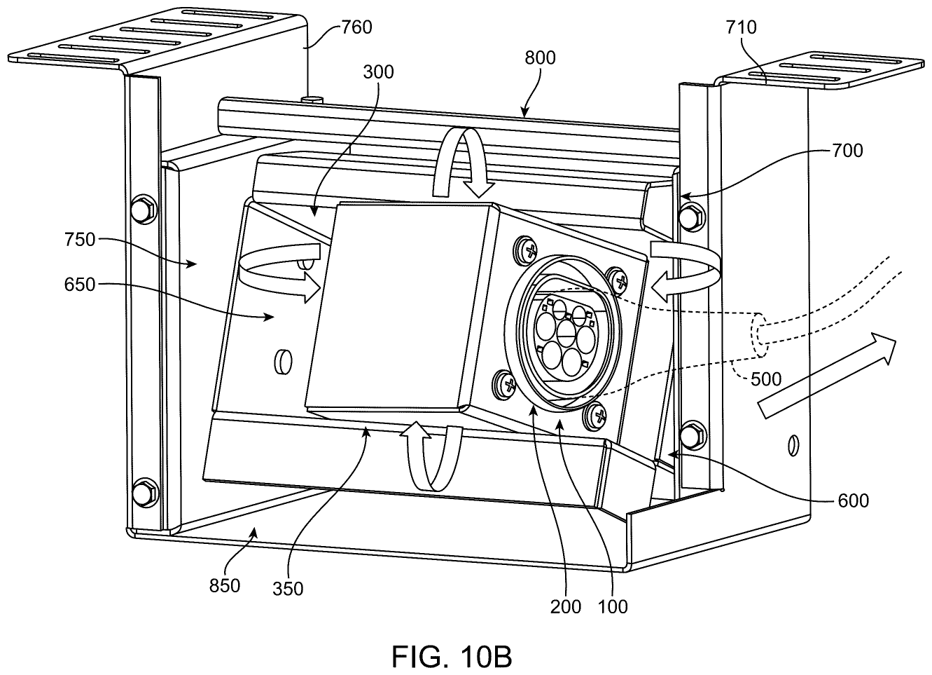

FIG. 10A illustrates a front top perspective view of an inlet system with a charging socket in a normal position, according to an embodiment of the disclosure. FIG. 10B illustrates a front top perspective view of an inlet system with a charging socket in a rotated position, according to an embodiment of the disclosure. The embodiment shown in FIGS. 10A and 10B may be a front top perspective view of the inlet system 20 described above referring to FIGS. 6 to 9. Referring to FIG. 10A, the charging connector 500 may be connected to the charging socket 200 in the normal position. In some cases, the equipment of the external power source to which the charging cable is connected may be positioned on a higher level than the inlet system 20. Even in this case, in the normal position, the charging cable may not be tense, and thus, the charging connector 500 and the cable connected to the charging connector 500 may be coupled to the inlet system 20 stably.

Referring to FIG. 10B, when the vehicle starts to move, for example, toward the left side without disconnecting the charging connector 500 from the charging socket 200, the charging cable connecting between the charging connector 500 and the equipment of the external power source located on the higher level may become tense, and the charging connector 500 may be pulled to the top right side. Accordingly, the first support 100 containing the charging socket 200, which is connected to the charging connector 500, starts to rotate counterclockwise due to a persistent pulling force to the right side. At the same time, the second support containing the first support 100, which is connected to the charging connector 500 via the charging socket 200, also starts to rotate upward due to a persistent pulling force to the upward.

As described above in FIGS. 2B, 4A, and 4B, at the moment of the rotation of the first support 100, the switch (400, FIG. 4B) may change its operation status from normally closed to normally open. Accordingly, the electronic connection between the charging connector 500 and the charging socket 200 is disconnected before the connection between the charging connector 500 and the charging socket 200 is physically disconnected. Thus, the charging socket 200 and the charging connector 500 can be protected from any damage caused by flowing electricity. In addition, the charging connector 500 may be pulled out from the charging socket 200 in the rotated position of the charging socket 200, which is horizontally, vertically adjusted to face toward the direction of the pulling force of the charging connector 500. Thus, the charging connector 500 can be pulled out from the charging socket 200 without any damage caused by an excessive angle that may be formed between the front of the charging socket 200 and the pulling direction of the charging connector 500.

Accordingly, the inlet system of the present disclosure can provide safe connection for charging by securing the safe electronical and mechanical disconnection between the inlet system 20 and the charging connector 500.

Additionally, during the rotated position, the springs (706, 756, FIGS. 7 and 8) may store potential energy, once the charging connector 500 is pulled out from the charging socket 200, the first support 100 and the second supports 300, 350, 600, 650 may move back and restore its normal position by this torsional energy without any manual control. Thus, the inlet system 20 can provide additional convenience to a user.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A system comprising:
a first support configured to hold a charging socket and including at least one first guide pin portion;
a second support configured to rotatably hold the first support in a horizontal plane and allow the first support to rotate horizontally according to movement of the charging socket; and
a switch positioned near at least one of the first support and the second supports, the switch configured to sense whether the first support rotates and switch the operation status of the charging socket when sensing the rotation of the first support.

2. The system of claim 1, wherein the switch is electronically connected to a control pin of the charging socket, and
wherein, when the switch senses the rotation of the first support, the switch changes the operation status from normally closed to normally open by electronically disconnecting the control pin.

3. The system of claim 1, wherein the first support includes at least one first guide pin portion, and
wherein the second support includes at least one first slotted hole portion through which the first guide pin portion penetrates and is configured to move along the path of the first slotted hole portion.

4. The system of claim 3, wherein each of the at least one first guide pin portion is connected to at least one of the top and the bottom of the first support,
wherein the second support includes at least one first plate, each of the at least one first plate positioned on the at least one of the top and the bottom of the first support, and
wherein each of the at least one first plate includes the first slotted hole portion formed therethrough.

5. The system of claim 4, wherein the at least one first guide pin portion penetrates through the at least one first slotted hole portion and protrudes over a surface of the at least one first plate, and
wherein the switch is positioned on the surface of the at least one first plate and senses whether the first support rotates by detecting movement of the protruded portion of the at least one first guide pin portion over the surface.

6. The system of claim 4, wherein each of the at least one first guide pin portion includes at least one first guide pin,
wherein each of at least one first slotted hole portion includes at least one first slotted hole corresponding to the at least one first guide pin, and
wherein each of the at least one first slotted hole has an arc shape.

7. The system of claim 6, wherein the at least one first guide pin includes a plurality of first guide pins, and the at least one first slotted hole includes a plurality of first slotted holes corresponding to the plurality of first guide pins, and
wherein the plurality of first slotted holes form portions of a circumference of a common imaginary circle, respectively.

8. The system of claim 6, wherein each of the at least one first plate further includes:
a first fixed pin fixedly connected to the each of the at least one first plate; and
a first spring positioned on the each of the at least one first plate such that two legs of the first spring are positioned between the first fixed pin and one of at least one first guide pin.

9. The system of claim 8, wherein each of the at least one first guide pin portion further includes a first center pin,
wherein each of at least one first slotted hole portion further includes a first center hole corresponding to the first center pin, and the first center hole has a circle shape that allows the first center pin to rotate according to movement of the charging socket, and
wherein a helical portion of the first spring between the two legs is mounted around the first center pin.

10. The system of claim 1, further comprising a third support,
wherein the second support further includes at least one second plate, each of the at least one second plate connected to the at least one side edge of the at least one first plate in a perpendicular direction to the at least one first plate,
wherein the third support is configured to rotatably hold the second support in a vertical plane from the at least one second plate, and
wherein the first support rotates in at least one of the horizontal plane and the vertical plane according to movement of the charging socket.

11. The system of claim 10, wherein each of the at least one second plate of the second support includes at least one second guide pin portion, and
wherein the third support includes at least one second slotted hole portion through which the second guide pin portion penetrates and is configured to move along the path of the second slotted hole portion.

12. The system of claim 11, wherein the third support includes at least one third plate, each of the at least one third plate positioned on the at least one second plate, and
wherein each of the at least one third plate includes the second slotted hole portion formed therethrough.

13. The system of claim 12, wherein each of the at least one second guide pin portion includes at least one second guide pin,
wherein each of at least one second slotted hole portion includes at least one second slotted hole corresponding to the at least one second guide pin, and
wherein each of the at least one second slotted hole has an arc shape.

14. The system of claim 13, wherein the at least one second guide pin includes a plurality of second guide pins, and the at least one second slotted hole includes a plurality of second slotted holes corresponding to the plurality of second guide pins, and
wherein the plurality of second slotted holes form portions of a circumference of a common imaginary circle, respectively.

15. The system of claim 13, wherein each of the at least one third plate further includes:
a second fixed pin fixedly connected to each of the at least one third plate, and
a second spring positioned on each of the at least one third plate such that the second spring connects between one of the at least one second guide pin and the second fixed pin.

16. The system of claim 15, wherein the second slotted hole corresponding to the second guide pin connected to the second spring includes a first end where the second guide pin connected to the second spring is positioned when the first support does not vertically rotate and a second end where the second guide pin connected to the second spring is positioned when the first support vertically rotates, and
wherein the second fixed pin is positioned closer to the first end than the second end.

17. A system comprising:
a first support configured to fixedly hold a charging socket;
a second support configured to rotatably hold the first support in a horizontal plane and to rotate itself in a vertical plane; and
a third support configured to rotatably hold the second support in the vertical plane,
wherein at least one of the second support and the third support rotates, according to movement of the charging socket.

18. The system of claim 17, further comprising a switch,
wherein the switch is positioned near at least one of the first support and the second supports and configured to sense whether the first support rotates and switch the operation status of the charging socket when sensing the rotation of the first support.

19. The system of claim 18, wherein the switch is electronically connected to a control pin of the charging socket, and
wherein, when the switch senses the rotation of the first support, the switch changes the operation status from normally closed to normally open by electronically disconnecting the control pin.

20. The system of claim 19, further comprising a bracket configured to hold the third support and to be connected to a vehicle.
